(19) United States
(12) Patent Application Publication
(10) Pub. No.: US 2013/0286234 A1
(43) Pub. Date: Oct. 31, 2013

(54) METHOD AND APPARATUS FOR REMOTELY MANAGING IMAGING

(71) Applicant: ATIF HUSSAIN, (US)

(72) Inventor: ATIF HUSSAIN, Hyderabad (IN)

(73) Assignee: ATIF HUSSAIN, HYDERABAD (IN)

(21) Appl. No.: 13/867,047

(22) Filed: Apr. 20, 2013

Related U.S. Application Data
(60) Provisional application No. 61/637,938, filed on Apr. 25, 2012.

(51) Int. Cl. H04N 5/232

(52) U.S. Cl. CPC H04N 5/23203
USPC 348/211.99

(57) ABSTRACT

Embodiments of the present invention generally relate to a method for remotely managing imaging. The method comprises remotely controlling capture of images, remotely monitoring the controlled capture of images and locally and remotely processing the captured images, wherein the processing the captured images comprises analyzing the captured images, recommending control information for recapture of images based on the analysis of the captured images, tracking efficacy of the recaptured images based on the recommendations, and post-processing the recaptured images.

### CROSS-REFERENCE TO RELATED APPLICATIONS

This application claims the benefit of the following provisional application, which is hereby incorporated by reference in its entirety: U.S. Provisional Patent Application No. 61/637,938, filed Apr. 25, 2012.

### BACKGROUND OF THE INVENTION

1. Field of the Invention

Embodiments of the present invention generally relate to remotely managing imaging, and more particularly, to remotely controlling and monitoring capturing of images via analyzing the captured images, recommending imaging control information for recapturing images and tracking efficacy of the recaptured images.

2. Description of the Related Art

Vibration (or camera shake) is a problem in photography. Camera shake induces blur in images owing to camera movement during image exposure. Moreover, slow shutter speeds and telephoto lenses exacerbate the effects of camera shake.

Image Stabilization (IS or camera shake) techniques have been used in a wide variety of applications including, but not limited to, surveillance, vehicle-mounted image sensor, robotics and consumer electronics. Image Stabilization is used to reduce blurring associated with the motion of a camera during exposure. Specifically, image stabilization is the process of eliminating or at least reducing the effects of unwanted image sensor motion (e.g., unwanted image sensor vibration or irregular image sensor motion) on still images or video sequences. For example, conventional image stabilization approaches attempt to eliminate or at least reduce the amount of unwanted image sensor motion relative to a scene, while preserving any intentional image sensor motion. In this regard, the conventional image stabilization techniques synthesize a new image or video sequence from the perspective of a stabilized image sensor trajectory. Also, image stabilization compensates for pan and tilt, i.e. angular movement, equivalent to yaw and pitch, of a camera or other imaging device.

However, with still cameras, camera shake is particularly problematic at slow shutter speeds or with long focal length, i.e. telephoto, lenses. In still photography, image stabilization can often permit the use of shutter speeds 2-4 stops slower (i.e. exposures 4-16 times longer), although even slower effective speeds have been reported. Still however, with video cameras, camera shake causes visible frame-to-frame jitter in the recorded video. Image stabilization does not prevent motion blur caused by the movement of the subject or by extreme movements of the camera. Image stabilization is only designed for and capable of reducing blur that results from normal, minute shaking of a lens due to hand-held shooting.

Among the primary classes of image stabilization techniques are mechanical image stabilization methods, electromechanical image stabilization methods, optical image stabilization methods, and electronic image stabilization methods.

Mechanical image stabilization systems attempt to dampen the motion of the image sensor (or just the lens/image sensor subsystem).

In conventional mounting of image capture equipment, which herein will be understood to encompass various kinds of imaging equipment, though previously the art was directed primarily to motion picture photographic equipment for example, stabilization of the equipment is desirable. Whether applicable to photographic, video, digital image, or another form of image capture equipment, which for convenience of reference will be herein referred to as a camera and the process of image capture as photographing though it is not intended that any limitation should be implied therefrom, the quality of the image sought to be recorded can easily be degraded due to unwanted movement of the camera. Such unwanted movement can be translational or rotational. As will be appreciated, unwanted rotational movement generally produces more striking and unwanted movement of the recorded image and is therefore particularly to be avoided. As an example, in mounting a camera on a moving vehicle, on land, water, or in air craft for example, the camera will be subjected to forces induced by vehicle movement. Acceleration, deceleration, centripetal, centrifugal, oscillatory and vibrational forces, to name a few ways of characterizing them, act on the camera, as well as the camera operator in applications where the camera is directly operator controlled.

As an example, recent innovations in camera mounting systems involving counterbalancing, gyrostabilization, and the like, directed to creating a steadier camera mount in applications where the camera is intended to move during photographing, have been developed to produce a more stable image and thus expand the range of photographic possibilities available. This is beneficial for example in cinematography where wider creative possibilities have been created through application of such technological advances. Nevertheless new problems of stabilization are continuously being encountered as new possibilities in camera mounting are being exploited. Also, problems inherent in conventional equipment have not been entirely overcome by recent advancements.

A technique that requires no additional capabilities of any camera body—lens combination consists of stabilizing the entire camera body externally rather than using an internal method. This is achieved by attaching a gyroscope to the camera body, usually utilizing the camera's built-in tripod mount. This allows the external gyro to stabilize the camera, and is typically employed in photography from a moving vehicle, when a lens or camera offering another type of image stabilization is not available.

Another technique for stabilizing a video or motion picture camera body is the Steadicam system which isolates the camera from the operator's body using a harness and a camera boom with a counterweight.

Several approaches have been developed to counteract the effects of camera shake. The oldest of these is the tripod, which can be very effective in minimizing the effects of camera shake. Unfortunately, tripods can be cumbersome, inconvenient, and time-consuming to use.

Electromechanical image stabilization systems detect motion of the image sensor using, for example, an inertial sensor, and alter the position or orientation of the image sensor to offset the detected image sensor motion. Optical image stabilization approaches stabilize the image of the sensor by displacing the image as it is formed by the lens system in a way that offsets image sensor motion. Electronic image stabilization techniques involve modifying the captured images in ways that makes the captured images appear to have been captured by a more stable image sensor. From the standpoint of implementation, the image stabilization may be divided into two types, namely lens-based and body-based stabilization. These refer to where the stabilizing system is located. However, both have their advantages and disadvantages.

In particular, optical image stabilization is used in a still camera or video camera to stabilize the recorded image by varying the optical path to the sensor. This technology is implemented in the lens itself, or by moving the sensor as the final element in the optical path. The key element of all optical stabilization systems is that they stabilize the image projected on the sensor before the sensor converts the image into digital information.

However, many image stabilization techniques are not suitable for compact camera environments, such as handheld electronic devices (e.g., mobile telephones), cameras designed for desktop and mobile computers (often referred to as “pc cameras”), and other embedded environments. For example, optical image stabilization techniques require large and bulky components that cannot be accommodated in most compact camera environments. Electronic image stabilization techniques, on the other hand, are computationally intensive and require significant memory resources, making them unsuitable in compact application environments in which processing and memory resources typically are significantly constrained.

During implementation of certain lens-based optical image stabilization techniques, it works by using a floating lens element that is moved orthogonally to the optical axis of the lens using electromagnets. Vibration is detected using two piezoelectric angular velocity sensors (often called gyroscopic sensors), one to detect horizontal movement and the other to detect vertical movement. As a result, this kind of image stabilizer only corrects for pitch and yaw axis rotations, and cannot correct for rotation around the optical axis. Some lenses have a secondary mode that counteracts vertical camera shake only. This mode is useful when using a panning technique, and switching into this mode depends on the lens; sometimes it is done by using a switch on the lens, or it can be automatic.

During implementation of yet other lens-based optical image stabilization techniques, lenses offer an Active Mode that is intended to be used when shooting from a moving vehicle, such as a car or boat, and should correct for larger shakes than the normal mode. However, active mode, when used under normal shooting conditions, can result in poorer results than the normal mode. This is because active mode is optimized for reducing higher angular velocity movements (typically when shooting from a heavily moving platform using faster shutter speeds), where normal mode tries to reduce lower angular velocity movements over a larger amplitude and timeframe (typically body and hand movement when standing on a stationary or slowly moving platform while using slower shutter speeds).

Most manufacturers suggest that the IS feature of a lens be turned off when the lens is mounted on a tripod as it can cause erratic results and is generally unnecessary. Many modern image stabilization lenses are able to auto-detect that they are tripod-mounted (as a result of extremely low vibration readings) and disable IS automatically to prevent this and any consequent image quality reduction. The system also draws power from the battery, so de-activating it when it is not needed will extend the time before a recharge is required.

However, one of the main disadvantages about lens-based image stabilization is the higher price tag that comes with it; image stabilization has to be paid for each lens anew. Also, not every lens is available as an image-stabilized variant. This is often the case for fast primes and wide-angle lenses. While the most obvious advantage for image stabilization lies with longer focal lengths, even normal and wide-angle lenses benefit from it in low-light applications. Furthermore, because light passing through the lens is shifted from its true optical path when it projects out the rear element onto the sensor, poor bokeh can result. However, this could be considered and compensated during the design stage of the lens. Lens based stabilization also has advantages over in-body stabilization. In low-light or low-contrast situations, the autofocus system (which has no stabilized sensors) is able to work more accurately when the image coming from the lens is already stabilized. In cameras with optical viewfinders, the image seen by the photographer through the stabilized lens (as opposed to in-body stabilization) reveals more detail because of its stability, and it also makes correct framing easier. However, this is especially the case with longer telephoto lenses.

Real-time digital image stabilization is used in some video cameras. This technique shifts the electronic image from frame to frame of video, enough to counteract the motion. It uses pixels outside the border of the visible frame to provide a buffer for the motion. This technique reduces distracting vibrations from videos or improves still image quality by allowing one to increase the exposure time without blurring the image. This technique does not affect the noise level of the image, except in the extreme borders when the image is extrapolated.

Unfortunately, many still camera manufacturers market their cameras as having digital image stabilization, when they really only have a mode with a sub-optimal image exposure time, resulting in pictures with less motion blur, but more noise.

The main disadvantage with this solution is that motion blur from shake under medium to low light conditions will be impossible to correct by the post processing images stabilization system, so in real life this will only work well for short exposure times (daylight).

Many non-linear editing systems use stabilization filters that can correct a non-stabilized image by tracking the movement of pixels in the image and correcting the image by moving the frame. The process is similar to digital image stabilization but since there is no larger image to work with, the filter either crops the image down to hide the motion of the frame or attempts to recreate the lost image at the edge through spatial or temporal extrapolation.

A yet another technique is stabilization in biological eyes. In many animals, including human beings, the inner ear functions as the biological analogue of an accelerometer in camera image stabilization systems, to stabilize the image by moving the eyes. When a rotation of the head is detected, an inhibitory signal is sent to the extra ocular muscles on one side and an excitatory signal to the muscles on the other side. The result is a compensatory movement of the eyes. Typically eye movements lag the head movements by less than 10 ms. However, this technique has its own disadvantages.

Still or motion image capturing devices, are commonly combined with mobile telecommunication devices, including smartphones, tablets, and the like. This is done so as to bundle multiple features for the user in a single device to attract a larger customer base. The increased volumes then lead to better economies of scale.

Several references made to various patent and non-patent literatures containing subject matter relating directly or indirectly to the field of the present invention include, but are not limited to, the aforementioned non-explicit citations, i.e. non-explicitly cited references, in connection with the methods, apparatuses and systems practiced in the state of the art.

Reference to the aforementioned non-explicit citations through the patent and non-patent literatures in this background section is not, and shall not be construed as, an admission by the applicants or their counsels that one or more literatures or publications from the above constitutes prior art in respect of the applicant's various inventions.

Upon having read and understood the Summary, Detailed Descriptions and Claims set forth below, those skilled in the art will appreciate that at least some of the systems, devices, components and methods disclosed in the aforementioned non-explicit citations disclosed herein may be modified advantageously in accordance with the teachings of the various embodiments of the present invention.

Therefore, there is still a need for the design and implementation of methods and apparatuses for remote managing imaging with enhanced qualitative and quantitative parameters, such as those with high economic feasibility and image stability.

### SUMMARY OF THE INVENTION

Embodiments of the present invention generally relate to a method for remotely managing imaging. The method comprises remotely controlling capture of images, remotely monitoring the controlled capture of images and locally and remotely processing the captured images, wherein the processing the captured images comprises analyzing the captured images, recommending control information for recapture of images based on the analysis of the captured images, tracking efficacy of the recaptured images based on the recommendations, and post-processing the recaptured images.

One or more embodiments of the invention generally relate to a system for remotely managing imaging comprising a capture subsystem for remote controlled capturing of images; and a control subsystem for remotely controlling the capturing of images. The control subsystem comprises a memory unit. The memory unit comprises an imaging management module. The imaging management module comprises an image processing sub module for processing captured images, an image analysis sub module for analyzing processed images, an imaging recommendation sub module for providing recommendations for selection of control parameters, and at least one of initialization and modification of the selected control parameters based on the analysis of the analyzed images, and an image stabilization sub module for image stabilization.

These and other systems, processes, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a system 100 for remotely controlling imaging, according to one or more embodiments;

FIG. 2 is a flow diagram of a method 200 for remotely controlling capture of images, as performed by the system 100, of FIG. 1, according to one or more embodiments;

FIG. 3 is a flow diagram of a method 300 for initiating image capturing and image capturing control, as performed by the system 100, of FIG. 1, according to one or more embodiments;

FIG. 4 is a flow diagram of a method 400 for determining the customized imaging control information, as performed by the system 100, of FIG. 1, according to one or more embodiments; and

FIG. 5 depicts a computer system that is a computing device and can be utilized in various embodiments of the present invention, according to one or more embodiments.

While the method and apparatus is described herein by way of example for several embodiments and illustrative drawings, those skilled in the art will recognize that the method and apparatus for remotely managing imaging, is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for remotely managing imaging defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

In certain embodiments, methods for remotely managing imaging with enhanced qualitative and quantitative parameters and systems facilitating implementation of such methods are disclosed. Stated differently, in certain such embodiments, systems and apparatuses for practicing the principles of the invention are disclosed. More specifically, the system and apparatus facilitate implementation of a method for remotely managing imaging with enhanced qualitative and quantitative parameters. Still more specifically, the systems and apparatuses facilitate implementation of a method for remotely managing imaging with enhanced qualitative and quantitative parameters, such as high economic feasibility, improved image stability, high adaptability, improved image capturability, reduced susceptibility to user or operator induced movements, increased power availability, improved ergonomics, improved operability, wired and wireless communicability, user selectable or automatic angular adjustability, user self image capturability, adaptive dynamic integrability or modularity, adaptive mountability, remote controllability, aerial mountability, six spatial degrees of freedom, adaptive configurability, and the like.

Various embodiments of a method and apparatus for remotely managing imaging are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

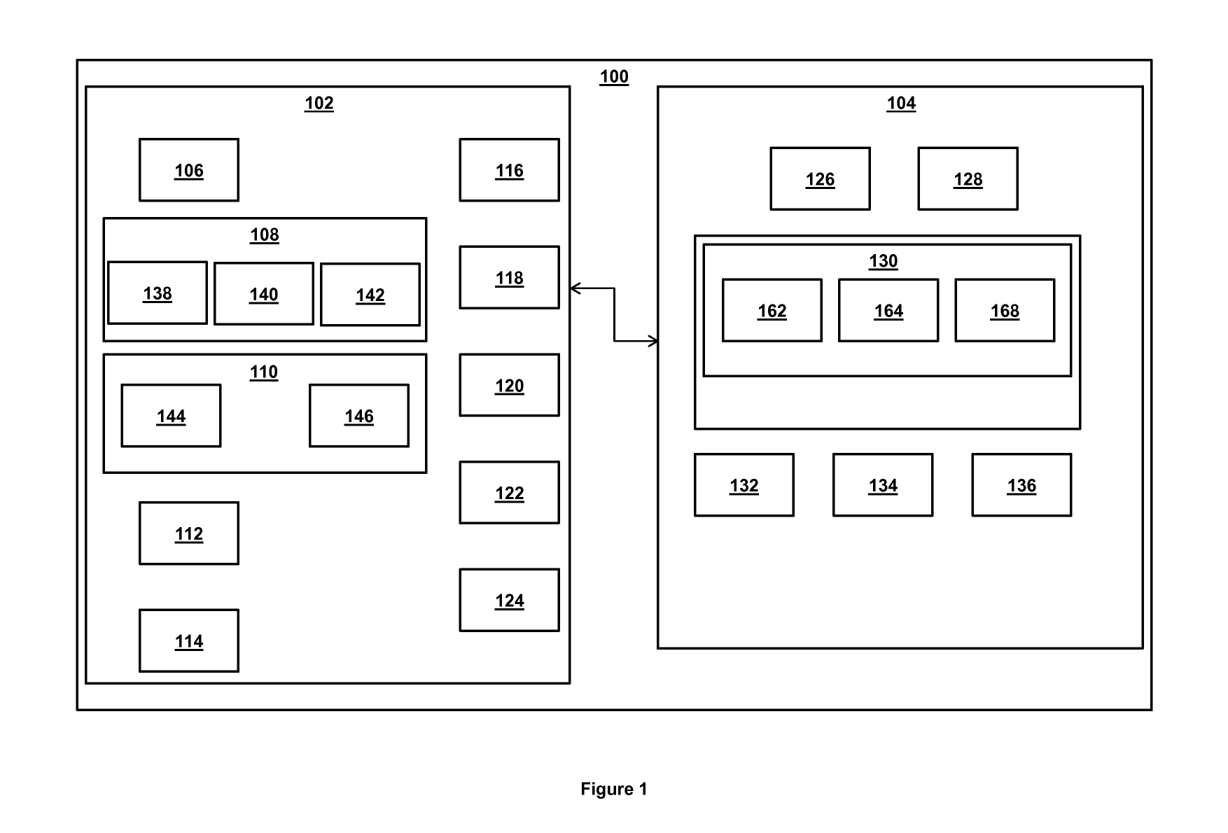

FIG. 1 depicts a block diagram of a system 100 for remotely managing imaging, according to one or more embodiments.

The system 100 may comprise a capture subsystem 102 and a control subsystem 104.

The capture subsystem 102 may comprise a sensing unit 106, a lens section unit 108, an actuation unit 110, a first wireless transceiver unit 112, a shutter unit 114, a focusing unit 116, a first Micro Processing Unit (or MPU) 118, a first memory unit 120, a first I/O unit 122 and support circuits 124.

In a nutshell, the capture subsystem 102 facilitates capturing of images, which is remotely controlled by the control subsystem 104. The capture subsystem 102 facilitates reception of control information for remote controlled imaging from the control subsystem 104. The capture subsystem 102 facilitates capture of images on the basis of the control information. The capture subsystem 102 facilitates optional local storage and processing of the captured images. The capture subsystem 102 facilitates transmission of the captured images to the control subsystem 104. The capture subsystem 102 is adapted to facilitate acquisition of images from any angle. The capture subsystem 102 is adapted to facilitate acquisition of self images of users from any angle.

In some embodiments, the capture subsystem 102 is adapted to mount on at least one of an adjustable tripod and stand, thereby facilitating addition of controls in connection with capturing height, pan and tilt, to the control subsystem 104. The capture subsystem 102 by virtue of adaptive mountability facilitates capturing of stable images despite extended capture durations.

In some embodiments, the capture subsystem 102 is adapted to facilitate capturing multimedia, such as a combination of audio, still images, video, or any other carrier signal. In some embodiments, the capture subsystem 102 is adapted to be located outdoors or at a high elevated point to capture weak signals unavailable in a cluttered indoors environment.

The term “carrier signal, carrier wave, or just carrier “refers to a waveform (usually sinusoidal) that is modulated (modified) with an input signal for the purpose of conveying information. The term “signal” includes, among others, audio, video, speech, image, communication, geophysical, sonar, radar, medical and musical signals.

The control subsystem 104 may comprise a second wireless transceiver 126, a second MPU 128, a second memory unit 130, a second I/O unit 132, a viewfinder unit 134 and miscellaneous controls unit 136.

The control subsystem 104 facilitates at least one of wiredly and wirelessly controlling the capture subsystem 102, thereby facilitating at least one of manually and automatically initiating operation of (or operating) the capture subsystem 102. For example, the control subsystem 104 facilitates at least one of manually and automatically, remotely switching “ON” the capture subsystem 102.

In a nutshell, the control subsystem 104 facilitates transmission of control information in connection with imaging to the capture subsystem 102. The control subsystem 104 facilitates remotely controlling and monitoring capturing of images by the capture subsystem 102 based on the control information. The control subsystem 104 facilitates reception, local processing and storage of the captured images from the capture subsystem 102. The local processing facilitated by the control subsystem 104 comprises analysis of the received, processed, and stored captured images, recommendation of customized control information in connection with imaging, and tracking efficacy of the captured images.

The capture subsystem 102 may be coupled to the control subsystem 104. In some embodiments, the capture subsystem 102 may be at least one of wiredly and wirelessly communicably operably coupled to the control subsystem 104.

In some embodiments, the capture subsystem 102 may be wiredly coupled to the control subsystem 104 through corresponding Universal Serial Bus (USB) interfaces, not explicitly described or shown herein. Specifically, the first and second I/O units 122 and 132 are wiredly coupled through the corresponding USB interfaces thereof.

In some embodiments, both the capture and control subsystems 102 and 104 are adapted to couple to at least one of aerially suspended and flying devices. By virtue of being coupled to at least one of aerially suspended and flying devices, the capture and control subsystems 102 and 104 together facilitate at least one of manually and automatically, at least one of wiredly and wirelessly selectable capturing for at least one of manually and automatically selectable angles.

The sensing unit 106 facilitates conversion of an optical image, i.e. optical or electromagnetic signals, of an object into electronic signals. In some embodiments, the sensing unit 106 may comprise one or more sensors. For example, the sensors 106 may be at least one of CCD image sensors and CMOS sensors.

The lens section unit 108 may comprise a lens module 138, a lens control module 140 and a flash module 142.

In some embodiments, the lens module 138 may comprise one or more lenses or assembly of lenses. The lens module 138 facilitates capturing the electromagnetic signals from the object and brings it to a focus on a film or the sensing unit 106.

The lens control module 140 facilitates controlling the lenses 138 and one or more quantitative control parameters thereof, such as zoom, focus, iris or aperture, Depth of Focus and Depth of Field (or DOF).

The flash module 142 facilitates production of a flash of artificial light at a given color temperature thereby facilitating illumination of a given scene or object. For example, a flash is to illuminate a dark scene. Other uses are capturing quickly moving objects or changing the quality of light.

The term “flash” refers either to the flash of light or to the flash module 142 discharging the light.

The term “flash synchronization (or sync or synch)” refers to firing of a flash coinciding with the shutter admitting light to photographic film or electronic image sensor.

In some embodiments, the system 100 may employ one or more wireless flash synchronization (or wireless sync) techniques. For example, the capture subsystem 102 may employ optical or radio triggering that requires no electrical connection (or wired) to the control subsystem 104. Thus, the capture and control subsystems 102 and 104 move without the restriction of cables, i.e. wirelessly. In some embodiments involving deployment of optical triggering, at least one flash module 142 may be electrically connected to the capture subsystem 102. A sensor (not explicitly described or shown herein), either built-in or external to a remote slave flash unit (not explicitly described or shown herein), of the capture subsystem 102, may sense the light from the master flash unit (not explicitly described or shown herein), of the control subsystem 104, and may cause the remote slave flash unit to fire. In some embodiments involving deployment of radio triggering, a transmitter (not explicitly described or shown herein) may be electrically connected to the control subsystem 104 to trigger a remote receiver (not explicitly described or shown herein) connected to a remote flash unit (not explicitly described or shown herein) of the capture subsystem 102.

However, many optical slave units may respond to pre-flash, thus firing an optical slave flash unit, of the capture subsystem 102, in advance. In some embodiments, instead of selecting a specific number of pre-flashes to ignore in order to manage the problem of pre-flash, an optical slave flash unit, of the capture subsystem 102, may have a learning mode. The learning mode teaches on which flash to synchronize upon firing one flash.

The actuation unit 110 may comprise at least a pair of motor (not shown here explicitly) for moving or controlling the camera subsystem 102. In some embodiments, the actuation unit 110 may comprise a pan motion actuator 144 and a tilt motion actuator 146. The actuation unit 110 may be operated by electric energy. In some embodiments, the actuation unit 110 facilitates conversion of the electrical energy into at least one of translational, rotational motions and a combination thereof.

The pan motion actuator 144 facilitates conversion of the electrical energy into pan motion.

Likewise, the tilt motion actuator 146 facilitates conversion of the electrical energy into tilt motion.

As used in photography, the term “pan or panning” refers to the rotation in a horizontal plane of a still or video camera. Panning a camera results in a motion similar to a human subject shaking head for “NO” or of an aircraft performing a yaw rotation.

The term “tilt or tilting” refers to a cinematographic technique in which the camera is stationary and rotates in a vertical plane (or tilting plane). Tilting the camera results in a motion similar to a human subject nodding head for “YES” or to an aircraft performing a pitch rotation.

The first wireless transceiver 112 may comprise of both a transmitter and a receiver, which are combined and share common circuitry or a single housing. The first wireless transceiver 112 facilitates transmission and reception of wireless signals.

The shutter unit 114 facilitates passage of light for a determined period of time, for the purpose of exposing a photographic film or the sensor 106 to light to capture a permanent image of an object.

The focusing unit 116 facilitates setting the lens 138 appropriate to the distance of the subject. For example, the focusing unit 116 may be an auto focusing unit. The auto focusing unit 138 may facilitate focusing the subject image, through the lens 138, onto the focal plane, i.e. the film or sensor 106.

In some embodiments, a combination of the first MPU 118, a first memory unit 120, first I/O unit 122 and support circuits 124, of the capture subsystem 102, comprise a first computing device (not shown here explicitly).

In some embodiments, a combination of the second MPU 128, second memory unit 130, second I/O unit 132 and support circuits 124, of the control subsystem 104, comprise a second computing device (not shown here explicitly).

Both the first and second MPUs 118 and 128 may comprise one or more commercially available microprocessors or microcontrollers that facilitate data processing and storage.

The various support circuits 124 facilitate the operation of the MPUs 118 and 128 and include one or more clock circuits, power supplies, cache, input/output circuits, and the like.

Both the first and second memory units 120 and 130 may comprise at least one of Read Only Memory (ROM), Random Access Memory (RAM), disk drive storage, optical storage, removable storage and/or the like. The memory units 120 and 130 may comprise an Operating System (or OS) 148.

As used in photography, the term “viewfinder” refers to what the photographer looks through to compose, and in many cases to focus, the picture. Most viewfinders are separate, and suffer parallax, while the single-lens reflex camera lets the viewfinder use the main optical system. Viewfinders are used in many cameras of different types, such as still and movie, film, analog and digital. A zoom camera usually zooms finder in synchronization with lens, one exception being rangefinder cameras.

In some embodiments, the viewfinder unit 134 may be an Electronic Viewfinder (or EVF). The EVF 134 facilitates electronic projection of the image captured by the lens 138 onto a miniature display. For example, the display may be a LCD display. The image on the display is used to assist in aiming the capture subsystem 102 at the scene to be photographed. The EVF 134 facilitates previewing the image after exposure.

Live preview is a feature that allows a display screen of a digital camera to be used as a viewfinder. Live preview provides a means of previewing framing and other exposure before capturing images. In most digital cameras, the preview is generated by means of continuously and directly projecting the image formed by the lens onto the main image sensor. The main image sensor in turn feeds the electronic screen with the live preview image. The electronic screen can be either a liquid crystal display (LCD) or an electronic viewfinder (EVF).

Through the Viewfinder photography (TtV) is a photographic or videographic technique in which a photograph or video or motion picture film is shot with one camera through the viewfinder of a second camera. The viewfinder thus acts as a kind of lens filter. The most popular method involves using a digital camera as the image taking camera and an intact twin-lens reflex camera (TLR) or pseudo-TLR as the “viewfinder” camera. TLRs typically have square waist-level viewfinders, with the viewfinder plane at 90 degrees to the image plane. The image in a TLR viewfinder is laterally reversed, i.e. it is a mirror image. Most photographers use a cardboard tube or similar contraption to connect the two cameras. The contraption serves to eliminate stray light and prevent reflections appearing on the viewfinder glass or on the lens of the imaging camera.

In certain experimental embodiments, the second memory unit 130 of the control subsystem 104 may comprise an imaging management module 158 (not shown here explicitly).

The imaging management module 158 may comprise an image processing sub module 160, an image analysis sub module 162, an imaging recommendation sub module 164 and an image stabilization sub module 168 (all not shown here explicitly).

The imaging management module 158 facilitates processing and analysis of captured images. The imaging management module 158 facilitates providing recommendations on the processed and analyzed images. The imaging management module 158 facilitates image stabilization.

In some embodiments, the image processing sub module 160 converts captured analog images into digital images. For example, the captured analog images are converted in digitized form, that is, arrays of finite length binary words. For digitization, the captured analog images are sampled on discrete grids and each sample or pixel is quantized using a finite number of bits. The digitized image is processed by a computer. To display a digital image, the digital image is first converted into analog signal, which is scanned onto a display.

In some embodiments, the image processing sub module 160 performs image enhancement. The term “image enhancement” refers to accentuation, or sharpening, of image features such as boundaries, or contrast to make a graphic display more useful for display and analysis. Image enhancement does not increase the inherent information content in data. Image enhancement includes gray level and contrast manipulation, noise reduction, edge crispening and sharpening, filtering, interpolation and magnification, pseudo coloring, and so on.

In some embodiments, the image processing sub module 160 performs image restoration. The term “image restoration” refers to filtering the observed image to minimize the effect of degradations. Effectiveness of image restoration depends on the extent and accuracy of the knowledge of degradation process as well as on filter design. Image restoration differs from image enhancement in that the latter is concerned with more extraction or accentuation of image features.

In some embodiments, the image processing sub module 160 performs image compression. The term “image compression” refers to minimizing the number of bits required to represent an image. Application of compression are in broadcast TV, remote sensing via satellite, military communication via aircraft, radar, teleconferencing, facsimile transmission, for educational and business documents, medical images that arise in computer tomography, magnetic resonance imaging and digital radiology, motion, pictures, satellite images, weather maps, geological surveys and so on. The objective of image compression is to reduce irrelevance and redundancy of the image data in order to be able to store or transmit data in an efficient form.

In some embodiments, the image analysis sub module 162 extracts meaningful information from images; mainly from digital images by means of digital image processing techniques.

In some embodiments, a display coupled to the second I/O unit 132, of the control subsystem 104, renders a Graphical User Interface (GUI) (not shown here explicitly). The GUI facilitates at least one of manually and automatically selecting the control parameters, and at least one of initializing and modifying the selected control parameters.

In some embodiments, the imaging recommendation sub module 164 provides recommendations in connection with at least one of selecting, initializing and modifying control parameters.

In some embodiments, the imaging recommendation sub module 164 provides recommendations for capturing images using images captured on the basis of default imaging control information. In some embodiments, the image analysis sub module 162 analyzes the images captured on the basis of default imaging control information.

In some embodiments, the images captured by the capture subsystem 102 are transmitted by the first wireless transceiver unit 112 to the second wireless transceiver 126 of the control subsystem 104. In some embodiments, the captured images received by the second wireless transceiver 126 are stored in the second memory unit 130. In some embodiments, the received and stored images are captured by the captured subsystem 102 on the basis of a default imaging control information provided by the control subsystem 104.

In some embodiments, the second MPU 128 accesses the second memory unit 130 to retrieve and implement the imaging management module 158. The imaging management module 158, in turn, calls or implements the image processing sub module 160. The image processing sub module 160 accesses the second memory unit 130 to retrieve the stored images.

The image processing sub module 160 calls or implements the image analysis sub module 162. The image analysis sub module 162 extracts meaningful information from the images, for example one or more attributes of the images, mainly from digital images by means of digital image processing techniques.

In general, there are many different techniques used in automatically analyzing images. Examples of image analysis techniques in different fields include: 2D and 3D object recognition, image segmentation, motion detection e.g. single particle tracking, video tracking, optical flow, medical scan analysis, 3D pose estimation, and automatic number plate recognition.

In some embodiments, the image analysis sub module 162 automatically analyzes the stored images to obtain useful information from the images. Specifically, the image analysis sub module 162 performs object-based image analysis comprising partitioning the images into meaningful image-objects, and assessing their characteristics through spatial, spectral and temporal scale.

The image analysis sub module 162 identifies one or more portions of the images, wherein each of the one or more portions of the images are interpreted as a single unit.

In some embodiments, the image analysis sub module 162 detects instances of semantic objects of a certain class, such as humans, buildings, or cars, in digital images and videos. Well-researched domains of object detection include face detection and pedestrian detection. The detection of instances of semantic objects in digital images and videos facilitates image retrieval.

In some embodiments, the image analysis sub module 162 finds objects in the images or a video sequence. For example, the image analysis sub module 162 employs at least one of artificial intelligence, pattern recognition and the like, for finding objects in the images.

In some embodiments, the image analysis sub module 162 employs approaches based on CAD-like object models for finding objects in the image or video sequence, for example edge detection, primal sketch, and the like. In some embodiments, the image analysis sub module 162 employs appearance-based methods for finding objects in the image or video sequence. The appearance-based methods use example images, called templates or exemplars, of the objects to perform recognition. In some scenarios, objects look different under varying conditions, for example changes in lighting or color, changes in viewing direction, changes in at least one of dimensions and geometries, and so on.

In some embodiments, the image analysis sub module 162 performs edge matching comprising detecting edges in templates and the images, comparing edges in the images to find the templates and considering range of possible positions in the templates. Upon completion of the edge matching, the image analysis sub module 162 performs one or more measurements comprising counting the number of overlapping edges, counting the number of template edge pixels with some distance of an edge in the search image, determining probability of distribution of distance to nearest edge in the search image, given the template is at correct position and estimating likelihood of each template position generating image.

In some embodiments, the image analysis sub module 162 performs divide-and-conquer search comprising searching, identifying and selecting onsider all positions as a set, wherein there is a cell in the space of positions, determining lower bound on score at best position in cell, determining whether or not the bound is excessivley large, in the event that the bound is excessivley large pruning the cell, in the event that the bound is not excessivley large dividing the cell into subcells, processing each subcell recursively and terminating the divide-and-conquer search in the event that the cell is excessively small. Unlike multi-resolution search, divide-and-conquer search finds all matches that meet the criterion assuming that the lower bound is accurate. In divide-and-conquer search the task of finding the bound comprises finding the lower bound on the best score, analyzing score for the template position represented by the center of the cell and subtracting maximum change occurring at cell corners from the center position for any other position in cell. In some embodiments, the image analysis sub module 162 is adapted to perform at least one of greyscale matching, gradient matching, histograms of receptive field responses and large model bases.

In some embodiments, the image analysis sub module 162 employs feature based methods for finding objects in the image or video sequence. Specifically, feature based methods comprise a search is used to find feasible matches between object features and image features. The primary constraint is that a single position of the object must account for all of the feasible matches. More specifically, feature based methods comprise methods that extract features from the objects to be recognized and the images to be searched, for example surface patches, corners and linear edges. In some embodiments, the image analysis sub module 162 implements interpretation trees a method for searching for feasible matches by searching through a tree, performs hypothesize and test method, pose consistency, pose clustering, invariance, geometric hashing, scale-invariant feature transform (SIFT), speeded up robust features (SURF).

In some embodiments, the image processing sub module 160 performs image segmentation for partitioning the images, for example digital images, into multiple segments (sets of pixels, also known as superpixels). The goal of segmentation is to simplify and/or change the representation of the images into something that is more meaningful and easier to analyze by the image analysis sub module 162. Image segmentation is typically used to locate objects and boundaries (lines, curves, etc.) in the images. More precisely, image segmentation is the process of assigning a label to every pixel in the image such that pixels with the same label share certain visual characteristics. The result of image segmentation is a set of segments that collectively cover the entire image, or a set of contours extracted from the image, as discussed in edge detection. Each of the pixels in a region of each of the images are similar with respect to some characteristic or computed property, such as color, intensity, or texture. Adjacent regions are significantly different with respect to the same characteristics. For example, image segmentation applied to a stack of images, typically in medical imaging, results in contours that can be used to create 3D reconstructions with the help of interpolation algorithms, like marching cubes.

The image processing sub module 160 generates profiles of the stored and processed images based on one or more attributes of the images.

In some embodiments, the image processing sub module 160 is adapted to generate profiles of the at least one of streaming multimedia, progressively downloadable media, audiovisual (AV) content, video, based on one or more attributes of the at least one of streaming multimedia, progressive downloadable media, audiovisual (AV) content, video.

In some embodiments, the image analysis sub module 162 takes into consideration one or more factors associated with the at least one of streaming multimedia, progressively downloadable media, audiovisual (AV) content, video and images, for analysis, thereby facilitating generation of profiles by the image processing sub module 160. For example, the image analysis sub module 162 takes into consideration the following real-time factors, entities, for instance mobile and static subjects and objects, activities or motions of the entities, scenes, scenarios, ambient optical, thermal and audio conditions, colors, shapes, textures, or any other information, and relationships between the mobile and static subjects and objects in the corresponding scenes, and scenarios, and the like, for analysis, thereby facilitating generation of profiles by the image processing sub module 160

In some embodiments, the image analysis sub module 162 is adapted to perform activity recognition. For example, the image analysis sub module 162 is adapted to perform at least one of sensor-based, single-user activity recognition, sensor-based, multi-user activity recognition, vision-based activity recognition through at least one of logic and reasoning, probabilistic reasoning, and based on at least one of Wi-Fi and data mining.

In some embodiments, the imaging recommendation sub module 164 provides recommendations in connection one or more tasks associated with imaging, such as controlling and monitoring capturing of images, analyzing the captured images and processing the captured images.

In some embodiments, the deployment of the system 100 facilitates remotely managing/controlling imaging. The system 100 implements the capture and control subsystems 102 and 104. In implementation, a user manually switches “ON” the control subsystem 104. The control subsystem 104 facilitates at least one of manually and automatically remotely switching “ON” the capture subsystem 102. The control subsystem 104 facilitates remotely controlling the capture subsystem 102. The capture subsystem 102 facilitates remote controlled capturing of images.

The control subsystem 104 facilitates initializing a default imaging control information. In some embodiments, the default imaging control information comprises at least one of automatically selected, initialized and modified control parameters with default values. For example, the default imaging control information comprises following at least one of automatically selected, initialized and modified control parameters: zoom, focus, at least one of iris and aperture, Depth of Focus, Depth of Field, pan, tilt, and the like, with default values.

In some embodiments, a display coupled to the second I/O unit 132, of the control subsystem 104, renders a Graphical User Interface (GUI) (not shown here explicitly). The GUI facilitates at least one of manually and automatically selecting the control parameters, and at least one of initializing and modifying the selected control parameters for use in controlling capturing of images.

In some embodiments, the default imaging control information is stored in the second memory unit 130, of the control subsystem 104. The second wireless transceiver 126, of the control subsystem 104, transmits the default imaging control information to the first wireless transceiver unit 112, of the capture subsystem 102. The default imaging control information is stored in the first memory unit 120. The first MPU 118 accesses the first memory unit 120 to retrieve and process the stored default imaging control information. The first MPU 118 instructs the capture subsystem 102, and the components thereof, thereby facilitating controlled capturing of images based on the default imaging control information.

In some embodiments, the captured images in analog form are converted into digital images.

The converted digital images are stored in the first memory unit 120, of the capture subsystem 102, for at least one of subsequent access, retrieval, and transmission to the control subsystem 104 for subsequently controlling recapturing of images. In some embodiments, the captured analog images are stored in the first memory unit 120.

The first wireless transceiver unit 112 transmits at least one of the converted digital images and captured analog images to the second wireless transceiver 126.

The second wireless transceiver 126 receives the converted digital images. The received digital images are stored in the second memory unit 130, of the control subsystem 104. The second MPU 128 accesses the second memory unit 130 to retrieve and process the stored digital images, captured on the basis of the default imaging control information.

In some embodiments, the display (not shown here explicitly) coupled to the second I/O unit 132 renders the stored digital images. The display facilitates previewing the stored digital images.

The control subsystem 104 facilitates determining customized imaging control information. The second MPU 128 accesses the second memory unit 130 to retrieve and implement the imaging management module 158. The imaging management module 158 calls or implements the image analysis sub module 162. The image analysis sub module 162 extracts meaningful information from the stored digital images by means of digital image processing techniques.

In some embodiments, the customized imaging control information comprises at least one of manually selected, initialized and modified control parameters control parameters with user-selected or fed values. For example, a user selects the control parameters and at least one of initializes and modifies the selected control parameters comprising zoom, focus, at least one of iris and aperture, Depth of Focus, Depth of Field, pan, tilt, and the like, with user-selected or fed values.

In some embodiments, the customized imaging control information is stored in the second memory unit 130. The second wireless transceiver 126 transmits the customized imaging control information to the first wireless transceiver unit 112. The customized imaging control information is stored in the first memory unit 120. The first MPU 118 accesses the first memory unit 120 to retrieve and process the stored customized imaging control information. The first MPU 118 instructs the capture subsystem 102, and the components thereof, thereby facilitating controlled recapturing of images based on the customized imaging control information.

In some embodiments, the recaptured images in analog form are converted into digital images.

The converted digital images are stored in the first memory unit 120 for at least one of subsequent access, retrieval, and transmission to the control subsystem 104 for subsequently controlling recapturing of images. In some embodiments, the recaptured analog images are stored in the first memory unit 120.

The first wireless transceiver unit 112 transmits at least one of the converted digital images and recaptured analog images to the second wireless transceiver 126.

In some embodiments, the display (not shown here explicitly) coupled to the second I/O unit 132 renders the converted digital images. The display facilitates previewing the converted digital images.

The second wireless transceiver 126 receives the converted digital images. The received digital images are stored in the second memory unit 130, of the control subsystem 104. The second MPU 128 accesses the second memory unit 130 to retrieve and process the stored digital images, captured on the basis of the customized imaging control information. The second MPU 128 accesses the second memory unit 130 to retrieve and implement the imaging management module 158.

The imaging management module 158 facilitates processing and analysis of captured images. The imaging management module 158 facilitates providing recommendations on the processed and analyzed images. The imaging management module 158 facilitates image stabilization.

The imaging management module 158 calls or implements the image analysis sub module 162, of the imaging management module 158 in the second memory unit 130 of the control subsystem 104. The image analysis sub module 162 extracts meaningful information from the stored digital images by means of digital image processing techniques.

The imaging management module 158 calls or implements the imaging recommendation sub module 164, of the imaging management module 158 in the second memory unit 130 of the control subsystem 104. The imaging recommendation sub module 164 provides recommendations for selection of the control parameters, and at least one of initialization and modification of the selected control parameters based on the analysis of the captured images.

The imaging management module 158 calls or implements the image processing sub module 160, of the imaging management module 158 in the second memory unit 130 of the control subsystem 104. In some embodiments, the image processing sub module 160 converts captured analog images into digital images. The image processing sub module 160 performs image enhancement, image restoration and image compression based on the recommendations.

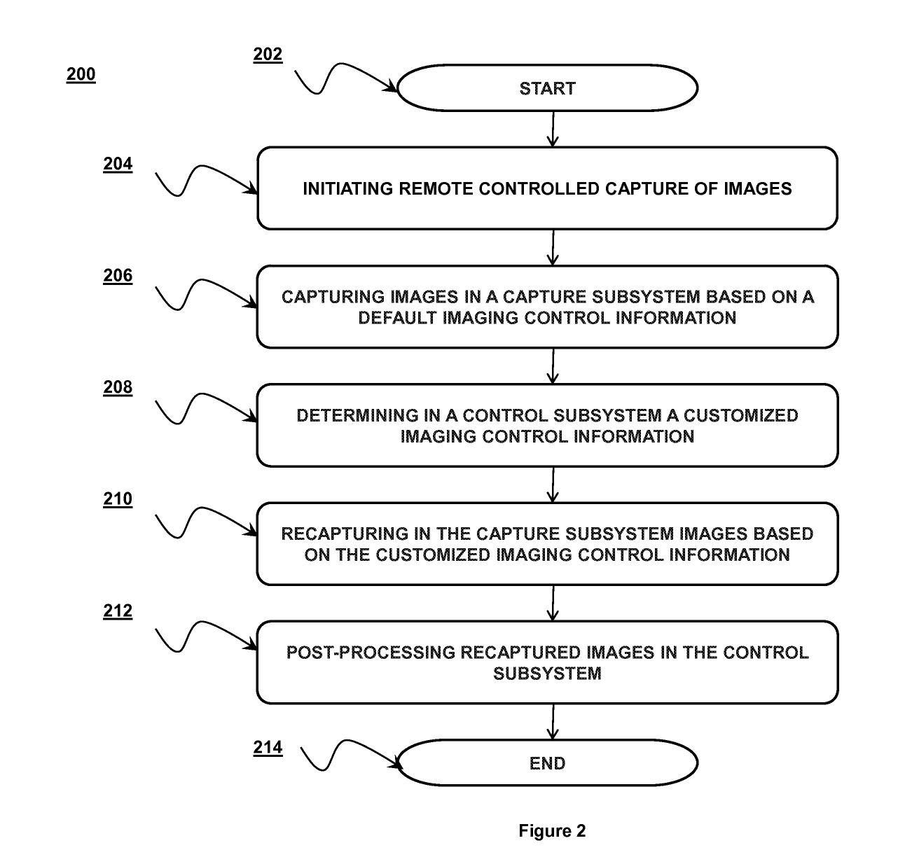

FIG. 2 is a flow diagram of a method 200 for remotely controlling capture of images, as performed by the system 100, of FIG. 1, according to one or more embodiments. The method 200 embodies the deployment and implementation of the system 100 and the components thereof.

The method 200 starts at step 202 and proceeds to step 204. At step 204, the method 200 facilitates initiating remote controlled capture of images. Specifically, the method 200 facilitates at least one of manually and automatically initiating operation of the control subsystem, for example the control subsystem 104 of the system 100, of FIG. 1, for at least one of wiredly and wirelessly controlling initiation of operation of the capture subsystem, for example the capture subsystem 102 of the system 100, of FIG. 1. The system 100 implements the capture and control subsystems 102 and 104. In implementation, a user manually switches “ON” the control subsystem 104. The control subsystem 104 facilitates at least one of manually and automatically remotely switching “ON” the capture subsystem 102.

At step 206, the method 200 facilitates implementation of the capture subsystem and control subsystems 102 and 104 for remote controlled capturing of images based on a default imaging control information. The control subsystem 104 facilitates remotely controlling the capture subsystem 102. The capture subsystem 102 facilitates remotely controlled capturing of images based on the default imaging control information. The method 200 proceeds to step 208.

At step 208, the method 200 facilitates implementation of the control subsystem 104 for determining customized imaging control information. The method 200 proceeds to step 210.

At step 210, the method 200 facilitates implementation of the capture subsystem 102 for recapturing images based on the customized imaging control information. The method 200 proceeds to step 212.

At step 212, the method 200 facilitates implementation of the imaging management module 158 for post-processing recaptured images. The method 200 proceeds to step 214 and ends.

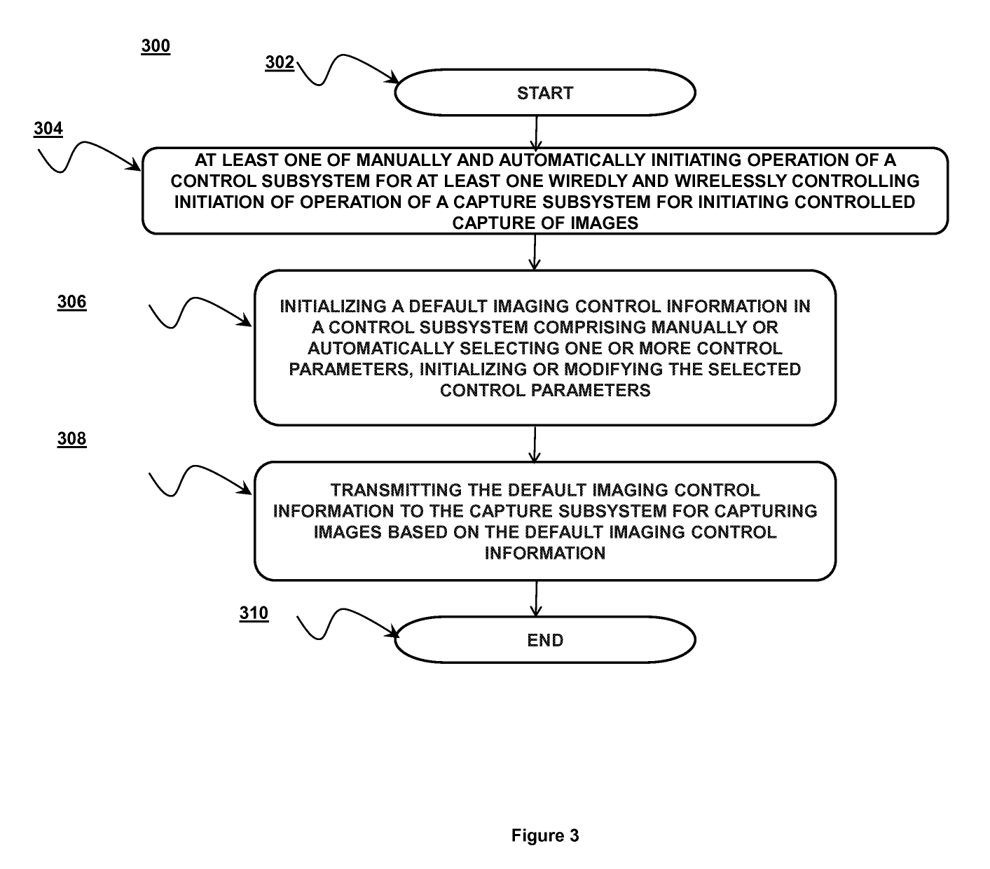

FIG. 3 is a flow diagram of a method 300 for initiating image capturing and image capturing control, as performed by the system 100, of FIG. 1, according to one or more embodiments. The method 300 facilitates initiating remotely controlled capturing of images, and remotely controlling the capture of images.

The method 300 starts at step 302 and proceeds to step 304. At step 304, the method 300 facilitates at least one of manually and automatically initiating operation of a control subsystem, for example the control subsystem 104 of the system 100, of FIG. 1, for at least one wiredly and wirelessly controlling initiation of operation of a capture subsystem, for example the capture subsystem 102 of the system 100, of FIG. 1.

The system 100 implements the capture and control subsystems 102 and 104. In implementation, a user manually switches “ON” the control subsystem 104. The control subsystem 104 facilitates at least one of manually and automatically remotely switching “ON” the capture subsystem 102. The method 300 proceeds to step 306.

At step 306, the method 300 facilitates implementation of the control subsystem 104 for initializing a default imaging control information in the control subsystem 104. In some embodiments, the default imaging control information comprises at least one of automatically selected, initialized and modified control parameters with default values. For example, the default imaging control information comprises following at least one of automatically selected, initialized and modified control parameters: zoom, focus, at least one of iris and aperture, Depth of Focus, Depth of Field, pan, tilt, and the like, with default values. In some embodiments, a display coupled to the second I/O unit 132, of the control subsystem 104, renders a Graphical User Interface (GUI) (not shown here explicitly). The GUI facilitates at least one of manually and automatically selecting the control parameters, and at least one of initializing and modifying the selected control parameters for use in controlling capturing of images. In some embodiments, the default imaging control information is stored in the second memory unit 130, of the control subsystem 104. The method 300 proceeds to step 308.

At step 308, the method 300 facilitates transmitting the default imaging control information to the capture subsystem for controlled capturing images based on the default imaging control information. The second wireless transceiver 126, of the control subsystem 104, transmits the default imaging control information to the first wireless transceiver unit 112, of the capture subsystem 102. The default imaging control information is stored in the first memory unit 120. The first MPU 118 accesses the first memory unit 120 to retrieve and process the stored default imaging control information. The first MPU 118 instructs the capture subsystem 102, and the components thereof, thereby facilitating controlled capturing of images based on the default imaging control information. The method 300 proceeds to step 310 and ends.

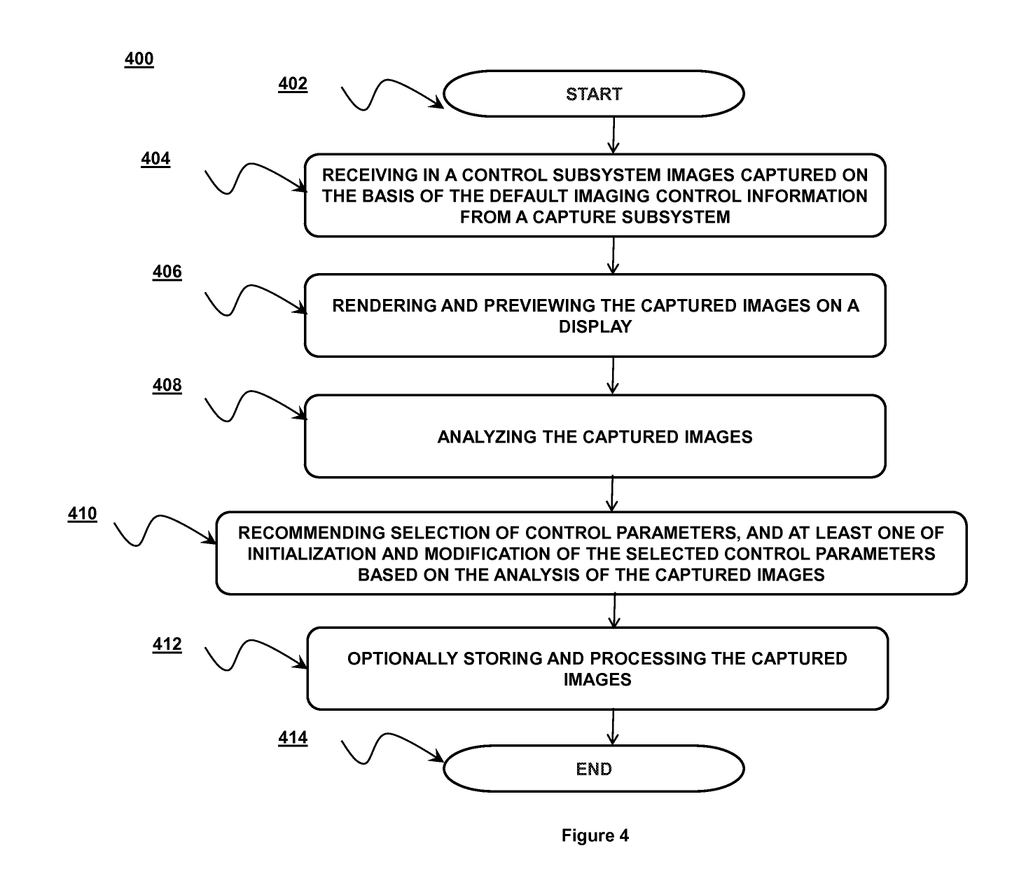

FIG. 4 is a flow diagram of a method 400 for determining the customized imaging control information, as performed by the system 100, of FIG. 1, according to one or more embodiments.

The method 400 starts at step 402 and proceeds to step 404. At step 404, the method 400 facilitates reception in the control subsystem, for example the control subsystem 104 of the system 100, of FIG. 1, of the images captured on the basis of the default imaging control information from the capture subsystem, for example the capture subsystem 102 of the system 100, of FIG. 1. The second wireless transceiver 126 receives the converted digital images, captured on the basis of the default imaging control information. The received digital images are stored in the second memory unit 130, of the control subsystem 104. The second MPU 128 accesses the second memory unit 130 to retrieve and process the stored digital images, captured on the basis of the default imaging control information. The method 400 proceeds to step 406.

At step 406, the method 400 facilitates rendering of the stored digital images, captured on the basis of the default imaging control information on the display (not shown here explicitly) coupled to the second I/O unit 132. The display facilitates previewing the stored digital images. The method 400 proceeds to step 408.

At step 408, the method 400 facilitates implementation of the imaging management module 158 in the second memory unit 130, of the control subsystem 104, for analyzing the stored digital images, captured on the basis of the default imaging control information. The second MPU 128 accesses the second memory unit 130 to retrieve and implement the imaging management module 158. The imaging management module 158 calls or implements the image analysis sub module 162. The image analysis sub module 162 extracts meaningful information from the stored digital images by means of digital image processing techniques. The method 400 proceeds to step 410.

At step 410, the method 400 facilitates implementation of the imaging recommendation sub module 164, of the imaging management module 158 in the second memory unit 130 of the control subsystem 104, for providing recommendations for selection of the control parameters, and at least one of initialization and modification of the selected control parameters based on the analysis of the stored digital images.

The imaging management module 158 calls or implements the imaging recommendation sub module 164, of the imaging management module 158 in the second memory unit 130 of the control subsystem 104. The method 400 proceeds to step 412.

At step 412, the method 400 facilitates implementation of the image processing sub module 160, of the imaging management module 158 in the second memory unit 130 of the control subsystem 104, for post-processing of stored digital images. The imaging management module 158 calls or implements the image processing sub module 160, of the imaging management module 158 in the second memory unit 130 of the control subsystem 104. In some embodiments, the image processing sub module 160 converts captured analog images into digital images. The image processing sub module 160 performs image enhancement, image restoration and image compression based on the recommendations. The method 400 proceeds to step 414 and ends.

In some embodiments, the customized imaging control information comprises at least one of manually selected, initialized and modified control parameters control parameters with user-selected or fed values. For example, a user selects the control parameters and at least one of initializes and modifies the selected control parameters comprising zoom, focus, at least one of iris and aperture, Depth of Focus, Depth of Field, pan, tilt, and the like, with user-selected or fed values.

In some embodiments, the customized imaging control information is stored in the second memory unit 130. The second wireless transceiver 126 transmits the customized imaging control information to the first wireless transceiver unit 112. The customized imaging control information is stored in the first memory unit 120. The first MPU 118 accesses the first memory unit 120 to retrieve and process the stored customized imaging control information. The first MPU 118 instructs the capture subsystem 102, and the components thereof, thereby facilitating controlled recapturing of images based on the customized imaging control information.

The embodiments of the present invention may be embodied as methods, system, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

### Example Computer System

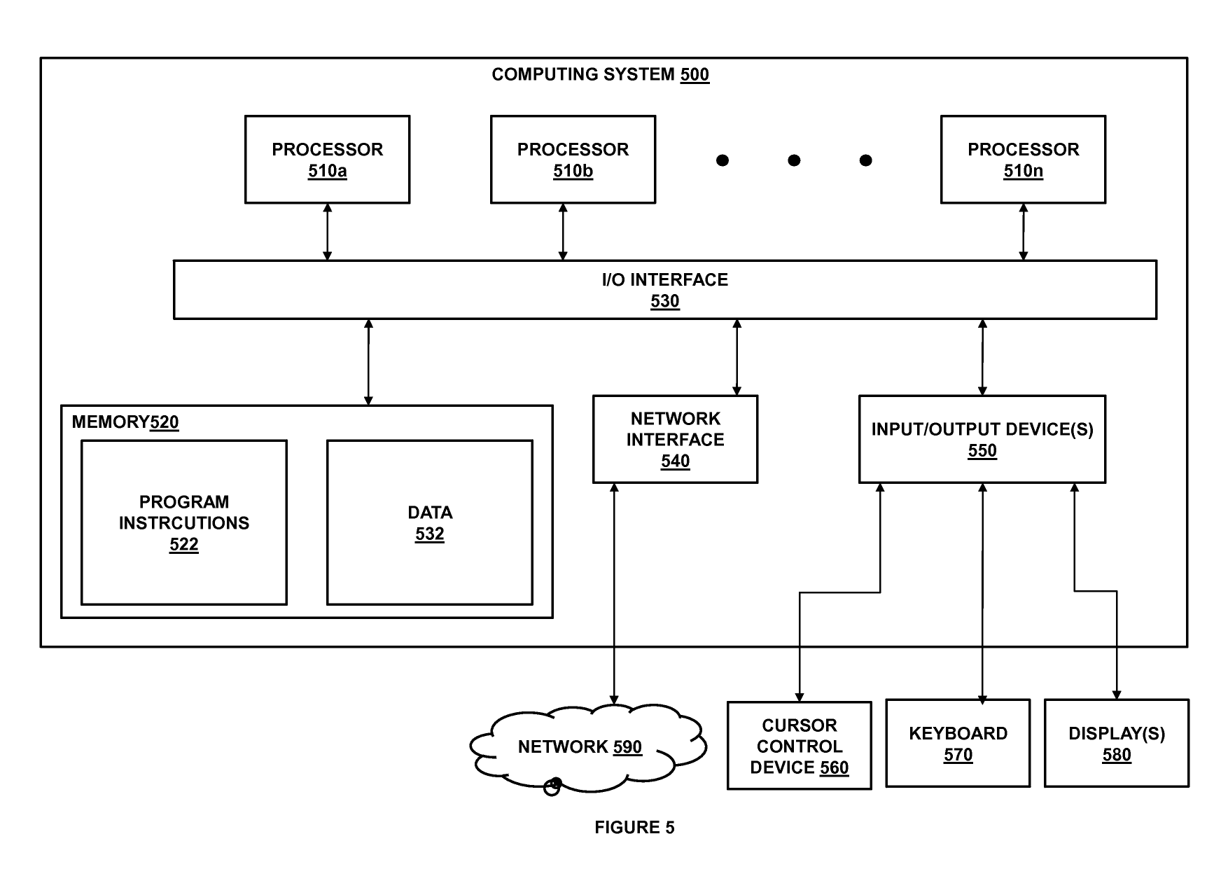

FIG. 5 depicts a computer system that is a computing device and can be utilized in various embodiments of the present invention, according to one or more embodiments.

Various embodiments of method and apparatus for remotely controlling imaging, as described herein, may be executed on one or more computer systems, which may interact with various other devices. One such computer system is computer system 500 illustrated by FIG. 5, which may in various embodiments implement any of the elements or functionality illustrated in FIGS. 1-4. In various embodiments, computer system 500 may be configured to implement methods described above. The computer system 500 may be used to implement any other system, device, element, functionality or method of the above-described embodiments. In the illustrated embodiments, computer system 500 may be configured to implement methods 200, 300 and 400, as processor-executable executable program instructions 522 (e.g., program instructions executable by processor(s) 510a-n) in various embodiments.

In the illustrated embodiment, computer system 500 includes one or more processors 510a-n coupled to a system memory 520 via an input/output (I/O) interface 530. The computer system 500 further includes a network interface 540 coupled to I/O interface 530, and one or more input/output devices 550, such as cursor control device 560, keyboard 570, and display(s) 580. In various embodiments, any of components may be utilized by the system to receive user input described above. In various embodiments, a user interface (e.g., user interface) may be generated and displayed on display 580. In some cases, it is contemplated that embodiments may be implemented using a single instance of computer system 500, while in other embodiments multiple such systems, or multiple nodes making up computer system 500, may be configured to host different portions or instances of various embodiments. For example, in one embodiment some elements may be implemented via one or more nodes of computer system 500 that are distinct from those nodes implementing other elements. In another example, multiple nodes may implement computer system 500 in a distributed manner.

In different embodiments, computer system 500 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 500 may be a uniprocessor system including one processor 510, or a multiprocessor system including several processors 510 (e.g., two, four, eight, or another suitable number). Processors 510a-n may be any suitable processor capable of executing instructions. For example, in various embodiments processors 510 may be general-purpose or embedded processors implementing any of a variety of instruction set architectures (ISAs), such as the x96, POWERPC®, SPARC®, or MIPS® ISAs, or any other suitable ISA. In multiprocessor systems, each of processors 510a-n may commonly, but not necessarily, implement the same ISA.

System memory 520 may be configured to store program instructions 522 and/or data 532 accessible by processor 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 520. In other embodiments, program instructions and/or data may be received, sent or stored upon different types of computer-accessible media or on similar media separate from system memory 520 or computer system 500.

In one embodiment, I/O interface 530 may be configured to coordinate I/O traffic between processor 510, system memory 520, and any peripheral devices in the device, including network interface 540 or other peripheral interfaces, such as input/output devices 550. In some embodiments, I/O interface 530 may perform any necessary protocol, timing or other data transformations to convert data signals from one components (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components, such as a north bridge and a south bridge, for example. Also, in some embodiments some or all of the functionality of I/O interface 530, such as an interface to system memory 520, may be incorporated directly into processor 510.

Network interface 540 may be configured to allow data to be exchanged between computer system 500 and other devices attached to a network (e.g., network 590), such as one or more external systems or between nodes of computer system 500. In various embodiments, network 590 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 540 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 550 may, in some embodiments, include one or more display terminals, keyboards, keypads, touchpads, scanning devices, voice or optical recognition devices, or any other devices suitable for entering or accessing data by one or more computer systems 500. Multiple input/output devices 550 may be present in computer system 500 or may be distributed on various nodes of computer system 500. In some embodiments, similar input/output devices may be separate from computer system 500 and may interact with one or more nodes of computer system 500 through a wired or wireless connection, such as over network interface 540.

In some embodiments, the illustrated computer system may implement any of the methods described above, such as the methods illustrated by the flowchart of FIGS. 2-4. In other embodiments, different elements and data may be included.

Those skilled in the art will appreciate that computer system 500 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for remote management of imaging, the method comprising:
remotely controlling capture of images;
remotely monitoring the controlled capture of images; and
locally and remotely processing the captured images, wherein the processing the captured images comprises analyzing the captured images, recommending control information for recapture of images based on the analysis of the captured images, tracking efficacy of the recaptured images based on the recommendations, and post-processing the recaptured images.

2. The method of claim 1, wherein the capture of images is facilitated using a capture subsystem, and wherein the remotely controlled capturing of images is facilitated using a control subsystem.

3. The method of claim 2, wherein the capture and control subsystems are at least one of wiredly and wirelessly communicably operably coupled.

4. The method of claim 2, wherein the control subsystem facilitates at least one of wiredly and wirelessly controlling, and at least one of manually and automatically operating, the capture subsystem.

5. The method of claim 2, wherein the capture subsystem is adapted to facilitate acquisition of images from any angle.

6. The method of claim 2, wherein the capture subsystem is adapted to facilitate acquisition of self images of users from any angle.

7. The method of claim 2, wherein both the capture and control subsystems are adapted to couple to at least one of aerially suspended and flying devices, thereby facilitating at least one of manually and automatically, and at least one of wiredly and wirelessly selectable capturing for at least one of manually and automatically selectable angles.

8. The method of claim 2, wherein the capture subsystem is adapted to mount on at least one of an adjustable tripod and stand, thereby facilitating addition of controls in connection with capturing height, pan and tilt to the control subsystem.

9. The method of claim 8, wherein the capture subsystem by virtue of adaptive mountability facilitates capturing of stable images despite extended capture durations.

10. The method of claim 1, wherein the remotely controlling capture of images comprises:
initiating remote controlled capture of images,
capturing images in a capture subsystem based on a default imaging control information,
determining in a control subsystem a customized imaging control information,
recapturing in the captured subsystem images based on the customized imaging control information, and
post-processing the recaptured images in the control subsystem.

11. The method of claim 10, wherein the initiating controlled capture of images comprises:
at least one of manually and automatically initiating operation of the control subsystem for at least one of wiredly and wirelessly controlling initiation of operation of the capture subsystem,
initializing a default imaging control information, in the control subsystem, via at least one of automatic selection of one or more control parameters and modification of the selected control parameters, and
transmitting the default imaging control information to the capture subsystem for capturing images based on the default imaging control information.

12. The method of claim 10, wherein the capturing images in the capture subsystem based on the default imaging control information comprises:
processing the images captured on the basis of the default imaging control information, and
storing the processed images for at least one of subsequent access, retrieval, and transmission to the control subsystem for subsequently controlling recapturing of images.

13. The method of claim 10, wherein the determining the customized imaging control information comprises:
receiving in the control subsystem the images captured on the basis of the default imaging control information from the capture subsystem,
rendering the captured images on a display,
previewing the captured images on the display,
analyzing the captured images, and
recommending selection of the control parameters, and at least one of initialization and modification of the selected control parameters based on the analysis of the captured images and
optionally storing and processing the captured images.

14. The method of claim 11, wherein the control parameters are quantitative parameters comprising:
zoom, focus, at least one of iris and aperture, Depth of Focus, Depth of Field, pan and tilt.

15. The method of claim 10, wherein the recapturing images based on the customized imaging control information comprises:
receiving the customized imaging control information from the control subsystem in the capture subsystem to recapture images based on the customized imaging control information, and
transmitting the recaptured images from the capture subsystem to the control subsystem.

16. The method of claim 15, wherein transmitting the recaptured images from the capture subsystem to the control subsystem further comprises:
rendering the recaptured images on a display in the control subsystem, and
previewing the recaptured images on the display.

17. The method of claim 12, wherein the processing the images captured on the basis of the default imaging control information further comprises:
optionally storing in the captured subsystem the captured images for subsequent access and retrieval,
compressing and encoding the stored captured images, and
optionally encrypting the compressed encoded images.

18. The method of claim 2, wherein the capture subsystem is adapted to facilitate capture of multimedia comprising a combination of at least one of audio, still images, video and any other carrier signal.

19. The method of claim 2, wherein the capture subsystem is adapted to be located outdoors at an elevated point to capture weak signals unavailable in a cluttered indoors environment.

20. A system for remotely managing imaging comprising:
a capture subsystem for facilitating remote controlled capture of images; and
a control subsystem for remotely controlling the capture of images comprising:
a memory unit comprising:
an imaging management module comprising:
an image processing sub module for processing the captured images comprising:
an image analysis sub module for analyzing the processed images,
an imaging recommendation sub module for providing recommendations for selection of control parameters, and at least one of initialization and modification of the selected control parameters based on the analysis of the analyzed images, and
an image stabilization sub module for image stabilization.
